(19) United States
(12) Patent Application Publication
(10) Pub. No.: US 2015/0075908 A1
(43) Pub. Date: Mar. 19, 2015

(54) LADDERS WITH PHOTO LUMINESCENT AND REFLECTIVE COMPONENTS AND RELATED COMPONENTS AND METHODS

(71) Applicant: Wing Enterprises, Incorporated, Springville, UT (US)

(72) Inventors: N. Ryan Moss, Mapleton, UT (US); Joe Bloomfield, Brea, CA (US); Sean R. Peterson, Santaquin, UT (US); Brian B. Russell, Salt Lake City, UT (US); Steve Puertas, Orem, UT (US)

(21) Appl. No.: 14/490,473

(22) Filed: Sep. 18, 2014

Related U.S. Application Data
(60) Provisional application No. 61/879,509, filed on Sep. 18, 2013.

(51) Int. Cl. E06C 7/00; G02B 7/182; E06C 1/04

(52) U.S. Cl. CPC E06C 7/003; E06C 1/04; E06C 7/00; G02B 7/182
USPC 182/207; 182/194; 29/402.01; 359/515; 116/209

(57) ABSTRACT

A visual indicator for a ladder is provided which may include a component having a photo luminescent material, a component have a reflective material, or both. In one embodiment, the visual indicator includes a rung plug having a cap portion and a body portion, the body portion being configured to be inserted into the interior hollow of a ladder rung such that the cap portion is visible along the side of an associated ladder rail. The cap portion may comprise a photo luminescent material, a reflective material or both. In one embodiment, the cap portion comprises a photo luminescent material while a separate reflective indicator is placed on the ladder rail at a location adjacent the rung plug.

### CROSS-REFERENCE TO RELATED APPLICATIONS

This application claims the benefit of U.S. Provisional Patent Application No. 61/879,509, filed Sep. 18, 2013, the disclosure of which is incorporated by reference herein in its entirety.

### TECHNICAL FIELD

The present invention relates generally to ladders and, more particularly, to components and features that may utilize photo luminescent materials, reflective materials, or both, as well as related methods.

### BACKGROUND

Ladders are conventionally utilized to provide a user thereof with improved access to elevated locations that might otherwise be inaccessible. Ladders come in many shapes and sizes, including straight ladders, extension ladders, stepladders, and combination step and extension ladders. So-called combination ladders may incorporate, in a single ladder, many of the benefits of multiple ladder designs.

Ladders known as straight ladders or extension ladders are ladders that are conventionally not self-supporting but, rather, are positioned against an elevated surface, such as a wall or the edge of a roof, to support the ladder at a desired angle. A user then ascends the ladder to obtain access to an elevated area, such as access to an upper area of the wall or access to a ceiling or the roof. A pair of feet or pads, each being coupled to the bottom of an associated rail of the ladder, are conventionally used to engage the ground or some other supporting surface.

In many cases, ladders are used in darkened environments including use during the dark of night without adequate lighting. For example, utility companies may utilize ladders before the sun has come up or after the sun has gone down, creating potential safety hazards. In one example, use of a ladder in inadequate lighting may make it difficult for a passerby to see the ladder—whether walking, riding a bike or driving an automobile. Additionally, working without adequate lighting may make it difficult for a worker to recognize the positioning of their ladder including the positioning and orientation of their ladder.

For these reasons and others, there is a continuing desire in the industry to provide improved functionality of ladders while also improving the safety and stability of such ladders.

### SUMMARY

Ladders, components for ladders and related methods are provided herein. In one embodiment, a ladder is provided that comprises a first pair of spaced apart rails, a plurality of rungs extending between and coupled to the first pair of spaced apart rails, and a plurality of visual markings formed on at least one of the rails of the pair of rails. The visual markings comprise a photo luminescent material.

In one embodiment, the plurality of visual markings further include a reflective material.

In one embodiment, each of the plurality of visual markings is positioned at a location that corresponds with a position of one of the plurality of rungs.

In one embodiment, a plurality of openings are defined in each of the rails, each of the plurality of openings corresponding with one of the plurality of rungs, and wherein each of the plurality of visual markings includes a plug at least partially disposed within an associated one of the plurality of openings.

In one embodiment, each of the plurality of plugs includes a body portion and a cap portion. The cap portion of the plug may comprise a photo luminescent material. At least a portion of the cap portion of the plug may include a reflective surface.

In one embodiment, the body portion of the plug is sized and configured to fit within an interior portion of a rung. In one particular embodiment, the body portion of the plug includes a plurality of interference ridges.

In one embodiment, the ladder is configured as at least one of a straight ladder, an extension ladder, a step ladder and an articulating ladder.

In one embodiment, the ladder includes a second pair of spaced apart rails slidably coupled with the first pair of spaced apart rails, a second plurality of rungs extending between and coupled to the second pair of spaced apart rails, and a second plurality of visual markings formed on at least one of the rails of the second pair of rails. The second plurality of visual markings comprises a photo luminescent material.

In accordance with another embodiment of the invention, a visual safety component for a ladder is provided. The component comprises a body portion sized and configured to be inserted into an interior portion of a ladder rung and a cap portion associated with the body portion, the cap portion including a photo luminescent material.

In one embodiment, the component additionally includes a reflective surface on a portion of the cap portion.

In one embodiment, the cap portion and the body portion are integrally formed.

In one embodiment, the cap portion includes a first portion coupled with the body portion, and a second portion, the second portion comprising the photo luminescent material.

In one embodiment, the body portion includes a plurality of interference ridges.

In accordance with another embodiment of the present invention, a method of retrofitting a ladder is provided. The method comprises providing a component comprising a photo luminescent material and inserting the component into an interior portion of a rung of the ladder.

In one embodiment, providing a component includes providing a component having a body portion for insertion into the interior portion of the rung and a cap, wherein at least a portion of the cap comprising the photo luminescent material.

In one embodiment, the method further comprises providing an interference fit between an external surface of the body portion and an internal surface of the rung. In one particularly embodiment, providing an interference fit between an external surface of the body portion and an internal surface of the rung includes providing the body portion with a plurality of interference ridges.

In one embodiment, the method further comprises providing a reflective surface adjacent to or on a portion of the component.

It is noted that the embodiments described herein are not to be considered mutually exclusive of one another and that any feature, aspect or component of one embodiment described herein may be combined with other features, aspects or components of other embodiments.

### BRIEF DESCRIPTION OF THE DRAWINGS

The foregoing and other advantages of the invention will become apparent upon reading the following detailed description and upon reference to the drawings in which:

FIG. 1 is a perspective view of a ladder according to an embodiment of the present invention;

FIG. 2 is side view of a portion of the ladder shown in FIG. 1;

FIG. 3 is a perspective view of a component of the ladder shown in FIG. 1;

FIG. 4 is a partially exploded view of the component shown in FIG. 3;

FIG. 5 is a top view of the component shown in FIG. 3;

FIG. 6 is a perspective view of a ladder according to another embodiment of the present invention;

FIG. 7 is side view of a portion of the ladder shown in FIG. 6;

FIG. 8 is the same view of the ladder as shown in FIG. 7, but depicting a dark environment with reflective lighting shining on the ladder;

FIG. 9 is the same view of the ladder as shown in FIG. 7, but depicting a completely dark environment with no reflective lighting.

### DETAILED DESCRIPTION

Various embodiments of ladders and ladder components are described herein. The described embodiments are not mutually exclusive of each other. Rather, various features of one described embodiment may be used in conjunction with features of other described embodiments.

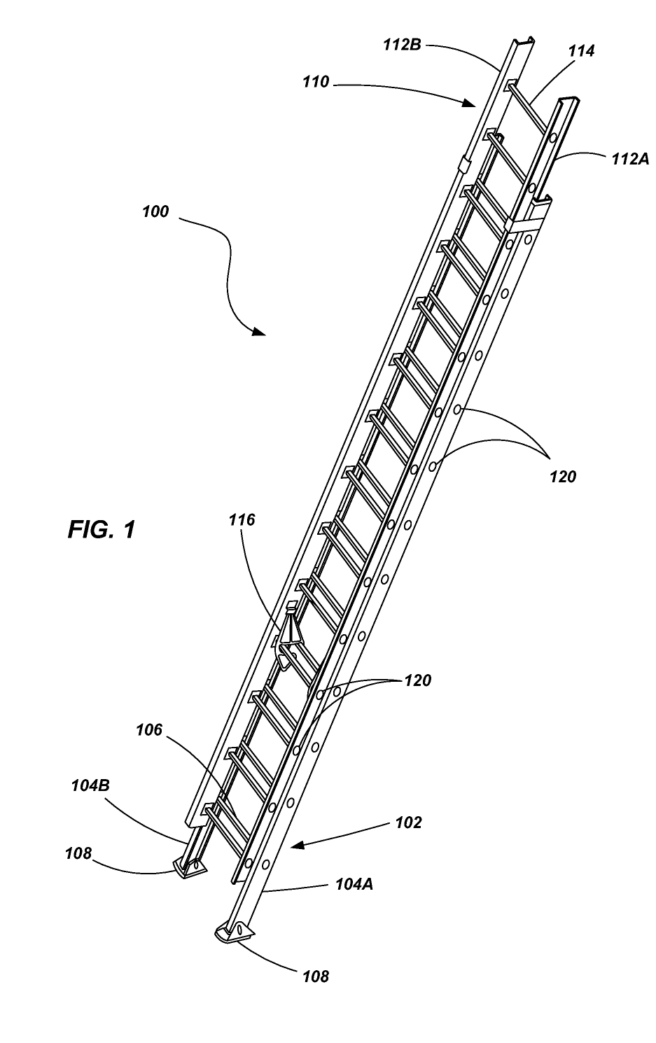

Referring to FIG. 1 a ladder 100 is shown. The ladder 100 includes a base section 102 having a pair of spaced apart rails 104A and 104B and a plurality of rungs 106 extending between, and coupled to, the rails 104A and 104B. A pair of feet 108 may be coupled to the lower portion of the rails 104A and 104B and be configured to engage the ground or other support surface upon which the ladder may be placed.

The ladder 100 further includes a fly section 110 that includes a pair of spaced apart rails 112A and 112B and a plurality of rungs 114 extending between, and coupled to, the rails 112A and 112B. The rails 112A and 112B of the fly section 110 are slidably coupled with the rails 104A and 104B of the base section 102 so that the fly section 110 may be adjusted relative to the base section 102.

One or more mechanisms, often referred to as a rung lock 116, may be associated with the base and fly sections 102 and 110 to enable selective positioning of the fly section 110 relative to the base section 102. This enables the ladder 100 to assume a variety of lengths (or, rather, heights when the ladder is in an intended operating orientation) by sliding the fly section 110 relative to the base section 102 and locking the two assemblies in a desired position relative to one another. By selectively adjusting the two rail assemblies 102 and 110 relative to each other, a ladder can be extended in length to nearly double its collapsed or shortest state, as will be appreciated by those of ordinary skill in the art. By way of example, a rung lock apparatus is described in U.S. Pat. No. 5,429,207 to Frank et al., issued Jul. 4, 1995, the disclosure of which is incorporated by reference herein in its entirety.

Thus, the ladder 100 shown in FIG. 1 may be adjusted to various heights depending on the needs of the user. As will be appreciated by those of ordinary skill in the art, the ladder 100 is generally configured as an extension ladder. However, the present invention may be practiced utilizing a variety of other types of ladders including straight ladders, articulating (or combination) ladders and step ladders. Various examples of ladders that may be used in accordance with the present invention include, without limitation, ladders described in U.S. patent application Ser. No. 14/049,927, filed on Oct. 9, 2013, U.S. Provisional Patent Application No. 62/045,979, filed on Sep. 4, 2014, and U.S. patent application Ser. No. 14/479,035, filed Sep. 5, 2014, the disclosures of which are incorporated by reference herein in their entireties.

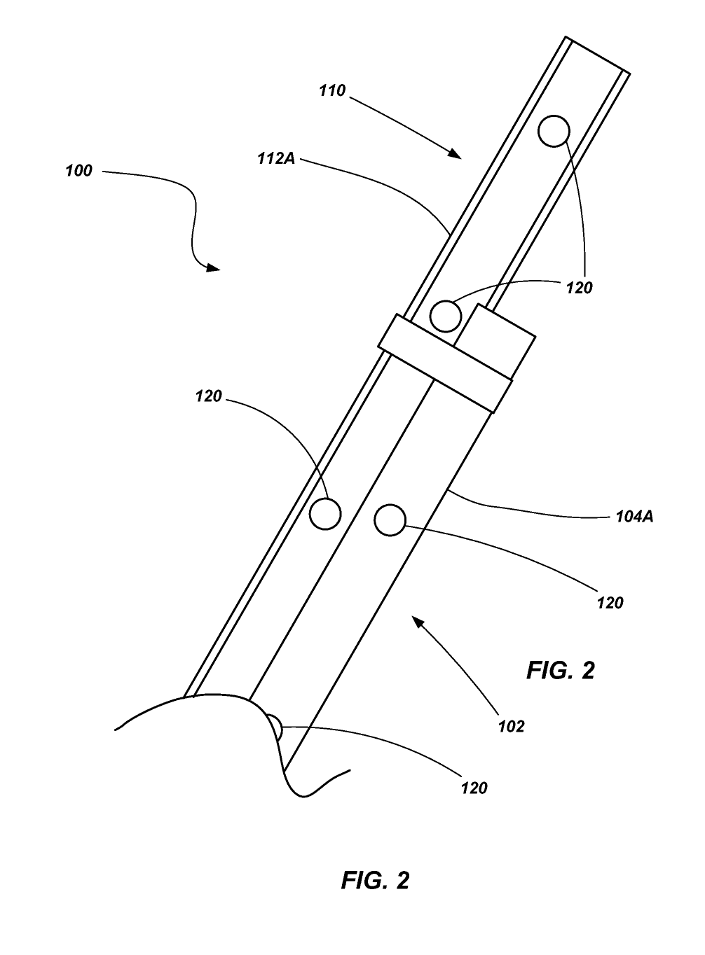

As seen in FIGS. 1 and 2, the ladder 100 further includes a plurality of visual markings 120 that may include a photo luminescent material, a reflective material, or both. In one embodiment, the visual markings 120 extend along the rails of the base section 102, the fly section 110, or both and may correspond in location with the ends of the rungs. Thus, the visual markings 120 are substantially evenly spaced along the respective base and fly sections 102 and 110.

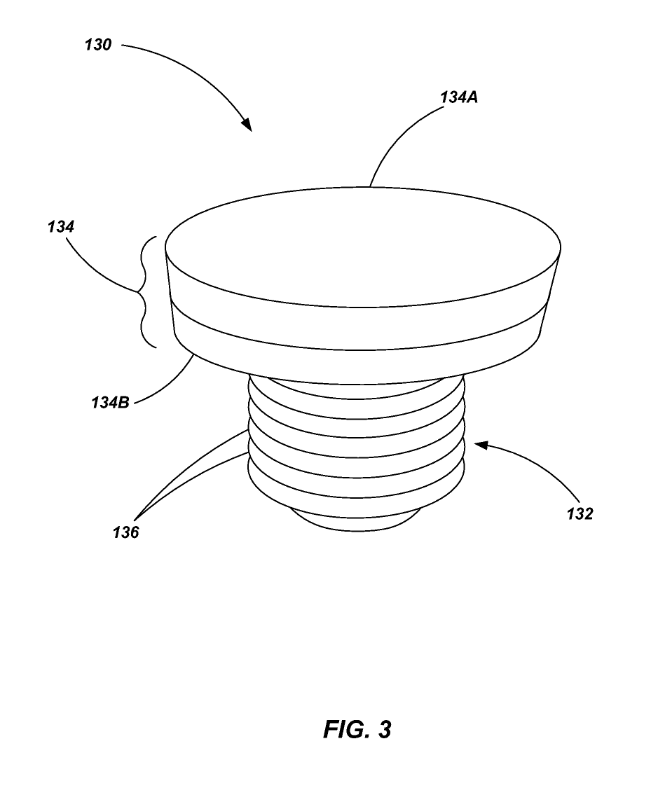

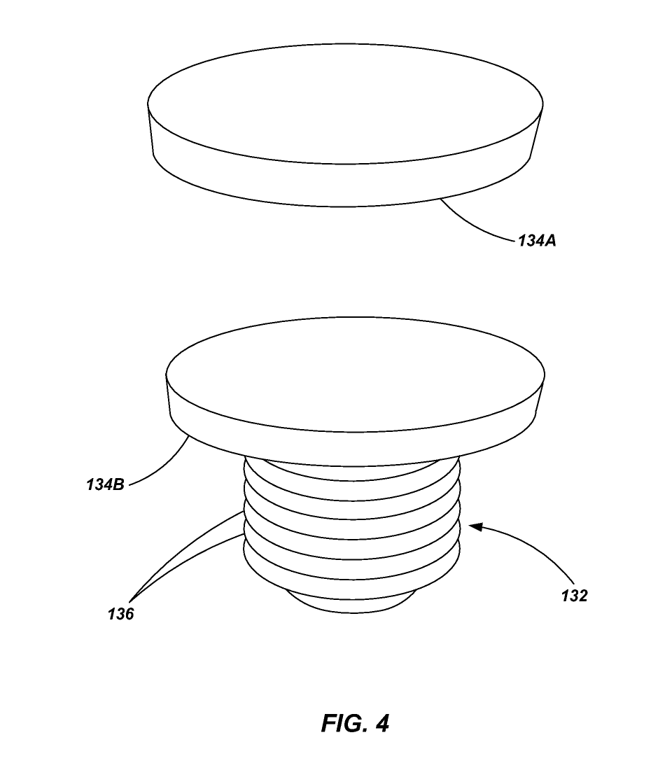

In one particular embodiment, the visual markings are provided by way of a rung plug. As seen in FIGS. 3 and 4, a plug 130 may be formed that includes a body 132 sized, shaped and configured to be inserted into an opening formed within a rail (e.g., 104A) at a location where a rung (e.g., 106) is coupled therewith. In many conventional ladders (particularly extension type ladders), an opening is formed in each side rail in association with a coupled rung, the openings being in communication with the interior of the rung. In the present case, the plug 130 is configured to fit into such openings of the side rails associated with the rungs.

In one embodiment, the plug 130 may be sized such that a “press fit” or an interference fit is accomplished when placing a portion of the plug through the opening and into the interior of the associated rung. In such a case, the body 132 of the plug 130 may be formed slightly larger than the opening in the rail and/or the interior space of the rung such that there is a tight frictional coupling between the body 132 of the plug 130 and at least one of the opening in the rail or the interior surface of the associated rung. In the embodiment shown in FIGS. 3 and 4, interference ridges 136 are provided on the body 132 for providing a frictional coupling with the rail and/or rung. In other embodiments, the plug 130 may be coupled with the rail and rung by other means including, for example, by way of an adhesive or through the use of mechanical fasteners. It is noted that the plugs may be configured to fit with a variety of sizes and shapes of rungs (e.g., round, D-shaped, square, etc.). Thus, the body 132 may exhibit a variety of cross-sectional geometries depending, for example, on the type and shape of openings and/or rungs that the plug will be inserted into. In one embodiment, the plug 130 and ladder rail (specifically the opening formed in the ladder rail) and rung may be cooperatively configured so that the outer surface of the plug becomes substantially flush with a surface of the outer surface of the associated ladder rail when the plug has been installed. In another embodiment, the plug, ladder rail and rung may be configured so that the plug protrudes from the rail of the ladder when installed.

The plug 130 additionally includes a cap portion 134 coupled with the body portion 132. In one embodiment, the cap portion 134 may be formed to include a first portion 134A and a second portion 134B. The first portion 134A may be formed as a separate and distinct component from the second portion 134B. In the embodiment shown, the second cap portion 134B is integrally formed with the body 132. The second portion 134B may be coupled or adhered with the first portion by an adhesive or by other appropriate mechanical features or components. In another embodiment, the entire plug may be formed as a substantially integral component if desired (i.e., the entire cap 134 and body 132 may be integrally formed).

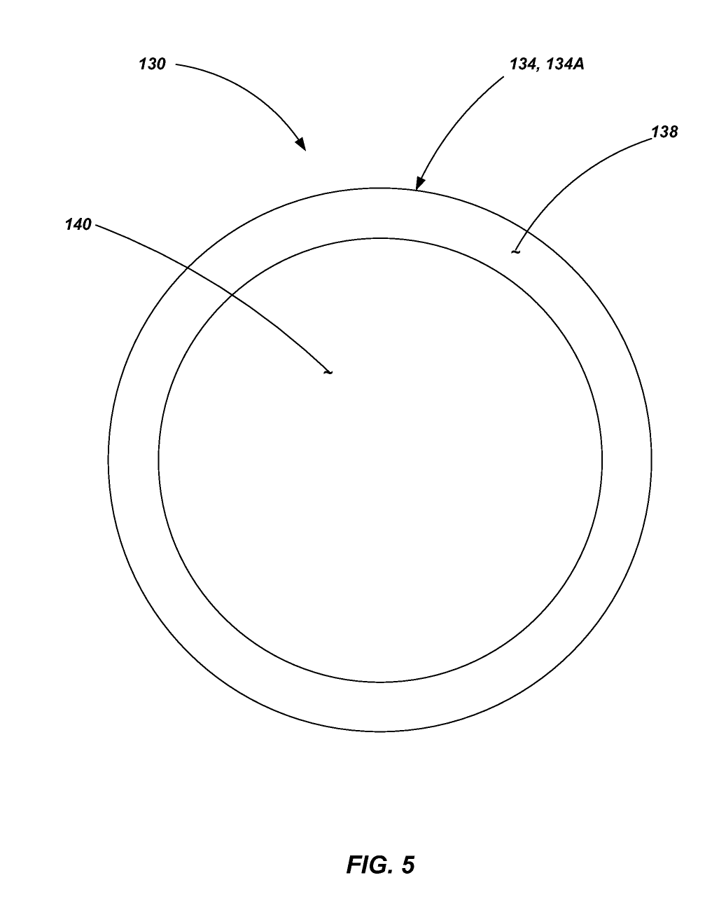

The plug 130 includes an exterior surface (e.g., on the cap portion 134) that is reflective, photo luminescent or both. In one example, such as shown in FIG. 5, the cap portion —more specifically, the first portion 134A of the cap 134—may include a first region 138 that is reflective while a second region 140 is luminescent. In another embodiment, the two regions may be reversed. In other embodiments, various patterns of reflection and luminescence may be provided. In yet other embodiments (as discussed below), the entire exposed surface of the plug 130 may be luminescent while a reflective material may be adhered to the ladder rail such as at a location that is adjacent to or surrounding the cap portion 134 of the plug 132.

In one embodiment, the entire plug 130 (FIGS. 3 and 4) may be formed of a photo luminescent material. In another embodiment, the body 132 and second portion 134B of the cap 134 may be integrally formed of a first material (e.g., a plastic or polymer material) while the first portion 134A of the cap 134 may be formed of a second material. In such an example, the second material may comprise a photo luminescent material while the first material does not. In one embodiment, the first portion 134A may be formed from a substantially homogenous photo luminescent material or it may just have a coating of photo luminescent material on an exposed surface thereof.

In one embodiment, luminescence may be provided by a material such as that which is available from Glow Zone, Inc., a company located in Brea, Calif. In one embodiment, the photo luminescent material includes photo luminescent crystals suspended in any of a variety of carriers (e.g., plastics, polymers, rubbers, epoxies, etc.) enabling ultraviolet light to pass through the carrier and charge the crystals more efficiently. Thus, the photo luminescent material may extend throughout the body of a component (e.g., through the depth of the cap portion 134 or through the entirety of the body portion 132) rather than just on the surface of a component. The crystals may be combined with a variety of pigments so as to provide a desired luminescent color. In some experiments, the photo luminescent material used in the plugs of the present invention has continued to provide luminescence for a period of more than 17 hours. Some available materials are believed to provide luminescence for approximately 50 hours or longer without the need to be recharged by exposure to a light source.

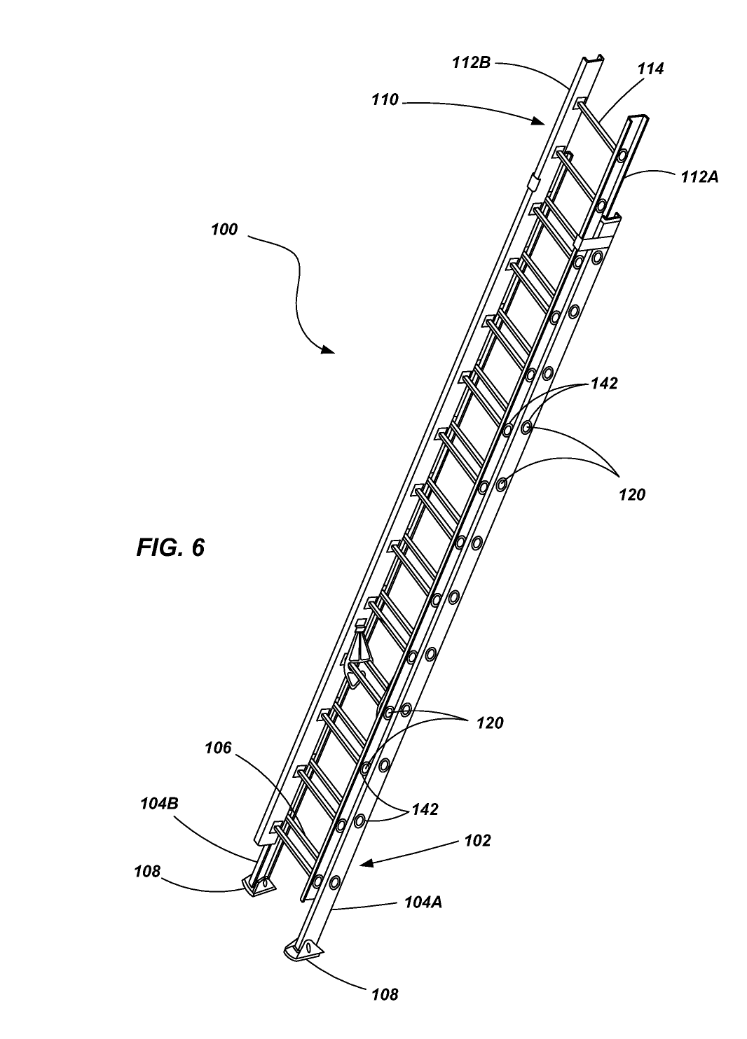

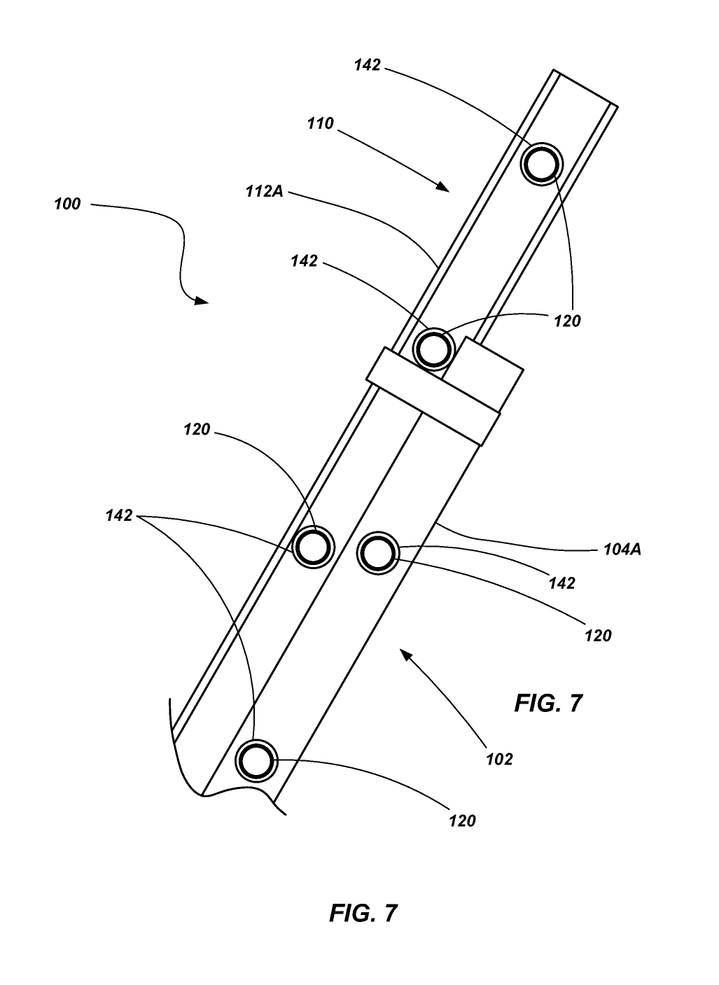

Referring now to FIGS. 6 and 7, a ladder 100 is shown with visual markings 120 in the form of plugs 130 positioned in the openings of the rails (104A, 104B, 112A, 112B) associated with the coupling of rungs (106, 114) thereto as well as reflective indicators 142 that may be adhered or affixed to the ladder rails adjacent to (e.g., surrounding) the plugs. The plugs 130 include a cap portion 134 (and optionally other components) comprising a photo luminescent material that charges when exposed to light (e.g., sunlight, incandescent light, fluorescent light) and then radiates in the absence of light. The reflective indicators 142 provide a high visibility reflection when the ladder 100 is in a poorly lit area and light (e.g., from a flash light, car lights, etc.) impinges on the reflective indicators 142.

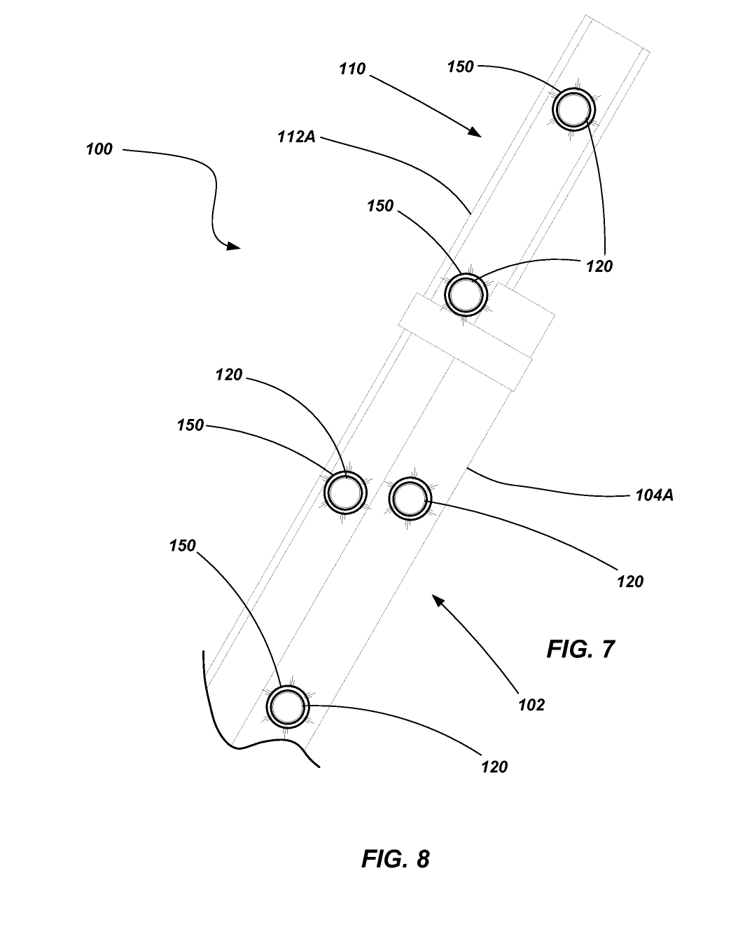

FIG. 8 is an illustration for the portion of the ladder 100 shown in FIG. 7, including visual markings, while the ladder is in a relatively dark environment (the structure of the ladder 100 being shown in dashed lines), but with a source light shining on the ladder 100. In this case, while the photo luminescent portion of the visual markings 120 (i.e., the plug 130) may or may not be visible (depending, e.g., on the brightness of the source light), the reflective indicators 142 provides substantial visibility to the presence of the ladder 100. Thus, for example, in a dark environment, a flashlight or the headlights of an automobile would reveal the presence of the ladder 100 at least by virtue of the reflective material.

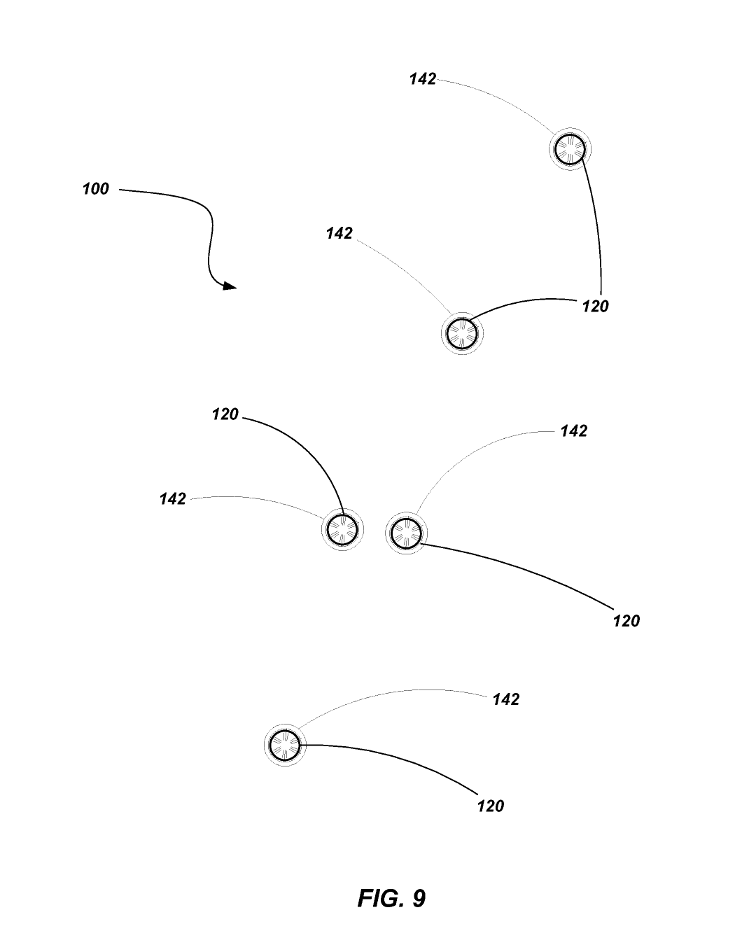

FIG. 9 is an illustration showing the ladder 100 in a dark environment and without a source light shining on the ladder 100. In this instance, the photo luminescent material of the plugs 130 is radiating indicating the presence of the ladder 100 even to a person that does not have a flash light or other light source. Thus, a user maintains awareness of the position of their ladder and passersby likewise are aware of its presence. The reflective material is not necessarily visible, but may be depending, for example, on the brightness and configuration of adjacent plugs 130.

The use of plugs 130 enables existing ladders to be retrofitted with visual markings 120 in a simple, efficient and effective manner. Many (if not most) ladders include openings in the rails associated with the rungs coupled thereto. Plugs may be provided that are photo luminescent, reflective or both, in common sizes corresponding with such openings. Additionally, such plugs may be installed by a user without tools (e.g., using a press fit) and without the need to structurally modify any components of a ladder.

It is noted that, in addition to providing visual indicators for the ladder, other practical advantages may be realized when using plugs in the rungs of ladders. For example, placing plugs in the rungs of ladders may prevent insects (spiders, bees, etc.) from residing within the hollow interiors of the rungs. Additionally, it is known that hollow rungs on ladders can create a howling sound when the ladder is placed on top of a vehicle and the vehicle is travelling at relatively high speeds. Use of a plug may also help to prevent such howling.

In other embodiments, other (or additional) components of the ladder may also be formed of a photo luminescent and/or reflective material. For example, the feet of the ladder, or caps placed on the tops of the rails may be formed of a photo luminescent material and/or include a reflective surface. Such a configuration may provide an indication to a user (e.g., emergency personnel such as fire fighters) with a visual indication of the location of their ladder during chaotic circumstances and time critical moments. In other embodiments, portions of the rungs may be formed of, or coated with, a photo luminescent and/or reflective material.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A ladder comprising:
a first pair of spaced apart rails;
a plurality of rungs extending between and coupled to the first pair of spaced apart rails;
a plurality of visual markings formed on at least one of the rails of the pair of rails, the visual markings comprising a photo luminescent material.

2. The ladder of claim 1, wherein the plurality of visual markings further include a reflective material.

3. The ladder of claim 1, wherein each of the plurality of visual markings is positioned at a location that corresponds with a position of one of the plurality of rungs.

4. The ladder of claim 1, wherein a plurality of openings are defined in each of the rails, each of the plurality of openings corresponding with one of the plurality of rungs, and wherein each of the plurality of visual markings includes a plug at least partially disposed within an associated one of the plurality of openings.

5. The ladder of claim 4, wherein each of the plurality of plugs includes a body portion and a cap portion.

6. The ladder of claim 5, wherein at least a portion of the cap portion of the plug comprises a photo luminescent material.

7. The ladder of claim 5, wherein at least a portion of the cap portion of the plug includes a reflective surface.

8. The ladder of claim 5, wherein the body portion is sized and configured to fit within an interior portion of a rung.

9. The ladder of claim 8, wherein the body portion includes a plurality of interference ridges.

10. The ladder of claim 1, wherein the ladder is configured as at least one of a straight ladder, an extension ladder, a step ladder and an articulating ladder.

11. The ladder of claim 1, further comprising:
a second pair of spaced apart rails slidably coupled with the first pair of spaced apart rails;
a second plurality of rungs extending between and coupled to the second pair of spaced apart rails;
a second plurality of visual markings formed on at least one of the rails of the second pair of rails, the second plurality of visual markings comprising a photo luminescent material.

12. A visual safety component for a ladder, the component comprising:
a body portion sized and configured to be inserted into an interior portion of a ladder rung;
a cap portion associated with the body portion, the cap portion including a photo luminescent material.

13. The component of claim 12, further comprising a reflective surface on a portion of the cap portion.

14. The component of claim 12, wherein the cap portion and the body portion are integrally formed.

15. The component of claim 12, wherein the cap portion includes a first portion coupled with the body portion, and a second portion, the second portion comprising the photo luminescent material.

16. The component of claim 12, wherein the body portion includes a plurality of interference ridges.

17. A method of retrofitting a ladder, the method comprising:
providing a component comprising a photo luminescent material;
inserting the component into an interior portion of a rung of the ladder.

18. The method according to claim 17, wherein providing a component includes providing a component having:
a body portion for insertion into the interior portion of the rung; and
a cap, at least a portion of the cap comprising the photo luminescent material.

19. The method according to claim 18, further comprising providing an interference fit between an external surface of the body portion and an internal surface of the rung.

20. The method according to claim 19, wherein providing an interference fit between an external surface of the body portion and an internal surface of the rung includes providing the body portion with a plurality of interference ridges.

21. The method according to claim 17, further comprising providing a reflective surface adjacent to or on a portion of the component.
